(19) United States
(12) Patent Application Publication
(10) Pub. No.: US 2020/0246825 A1
(43) Pub. Date: Aug. 6, 2020

(54) Tripod Hose Spray Nozzle Attachment

(71) Applicant: Tracy Kessling, Hollidaysburg, PA (US)

(72) Inventor: Tracy Kessling, Hollidaysburg, PA (US)

(21) Appl. No.: 16/269,335

(22) Filed: Feb. 6, 2019

(51) Int. Cl. B05B 15/625; F16M 11/34; F16M 11/36; F16L 3/00

(52) U.S. Cl. CPC B05B 15/625; F16L 3/003; F16M 11/36; F16M 11/34

(57) ABSTRACT

A tripod hose spray nozzle attachment for providing an elevated, aimable, water stream includes a tripod platform having a top side and a bottom side. The top side has a hose aperture extending through the bottom side. A plurality of legs is coupled to the bottom side and to form a tripod base. A hose fitting is coupled to the bottom side and is in fluid communication with the hose aperture. A flexible hose neck is coupled to the top side and is in fluid communication with the hose aperture. An adjustable spray nozzle has an attachment end coupled to a distal end of the flexible hose neck and a spray end having a plurality of apertures to release the water from the flexible hose neck. The spray end has an adjustment mechanism to alter the flow rate and concentration of the water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to hose attachments and more particularly pertains to a new hose attachment for providing an elevated, aimable, water stream.

### BRIEF SUMMARY OF THE INVENTION

An embodiment of the disclosure meets the needs presented above by generally comprising a tripod platform having a top side and a bottom side. The top side has a hose aperture extending through the bottom side. A plurality of legs is coupled to the bottom side and extends at an angle to form a tripod base. A hose fitting is coupled to the bottom side and is in fluid communication with the hose aperture. The hose fitting is configured to receive a standard garden hose. A flexible hose neck is coupled to the top side and is in fluid communication with the hose aperture. The flexible hose neck flexes such that it can change shape and direction under the manipulation of a user's hand yet maintains shape under the forces of gravity and the flow of water passing therethrough. An adjustable spray nozzle has an attachment end coupled to a distal end of the flexible hose neck and a spray end having a plurality of apertures to release the water from the flexible hose neck. The spray end has an adjustment mechanism to alter the flow rate and concentration of the water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a tripod hose spray nozzle attachment according to an embodiment of the disclosure.

FIG. 2 is a side elevation view of an embodiment of the disclosure.

FIG. 3 is a cross-sectional view of an embodiment of the disclosure along line 3-3 of FIG. 2.

FIG. 4 is a bottom plan view of an embodiment of the disclosure.

### DETAILED DESCRIPTION OF THE INVENTION

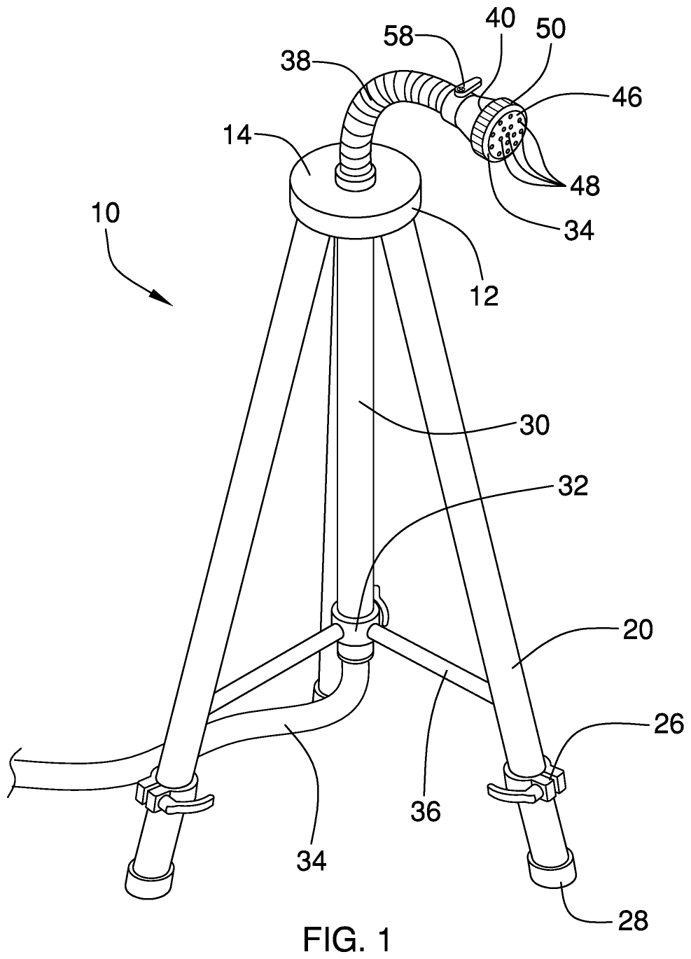

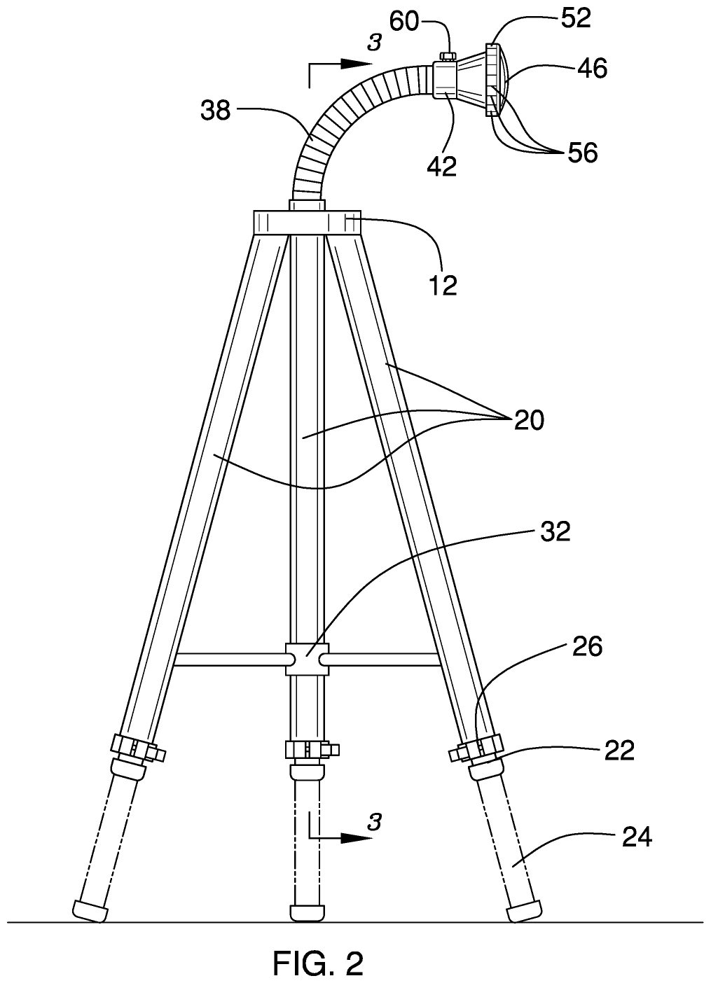

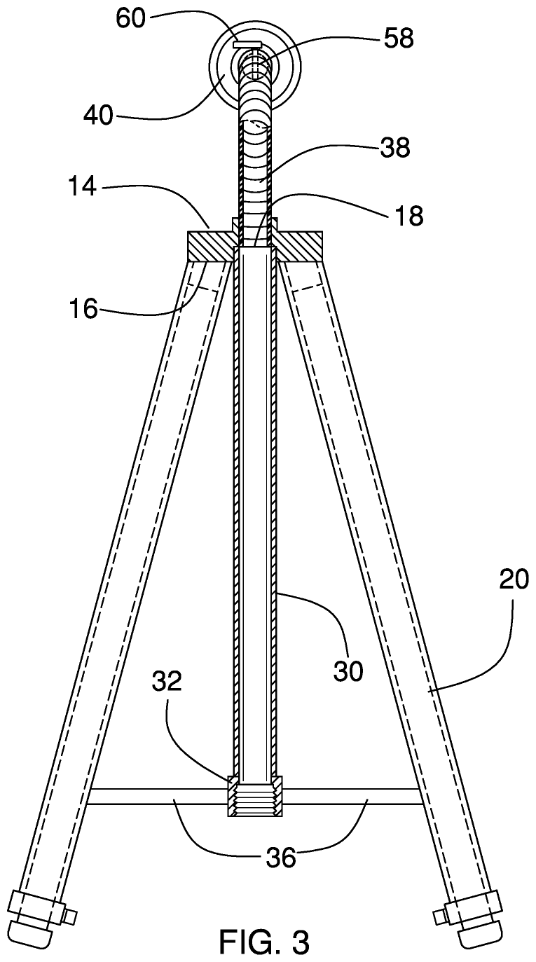

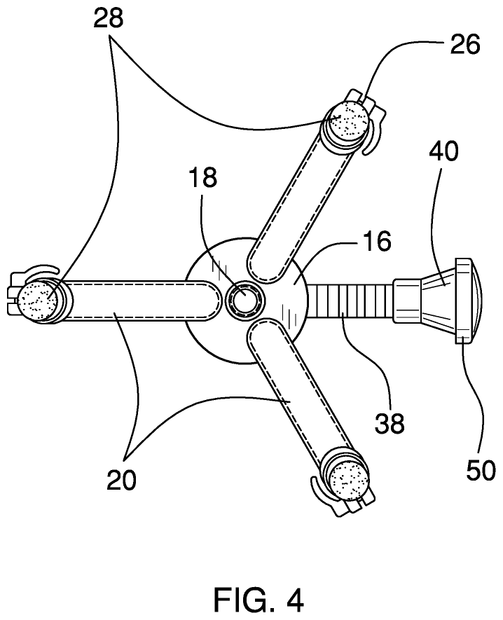

With reference now to the drawings, and in particular to FIGS. 1 through 4 thereof, a new hose attachment embodying the principles and concepts of an embodiment of the disclosure and generally designated by the reference numeral 10 will be described.

As best illustrated in FIGS. 1 through 4, the tripod hose spray nozzle attachment 10 generally comprises a tripod platform 12 having a top side 14 and a bottom side 16. The top side 14 has a hose aperture 18 extending through the bottom side 16. The tripod platform 12 may be disc shaped. A plurality of legs 20 is coupled to the bottom side 16 and extends at an angle to form a tripod base. Each of the plurality of legs 20 telescopes between a collapsed position 22 and an alternate extended position 24. Each of the plurality of legs 20 may have a locking clamp 26 to maintain the collapsed position 22, the alternate extended position 24, or any intermediate position therebetween. A plurality of rubber feet 28 may be coupled to the plurality of legs for increased stability. An attachment extension 30 may be coupled to the bottom side 16. The attachment extension 30 vertically extends down from the tripod platform 12 between the plurality of legs 20 and is in fluid communication with the hose aperture 18. A hose fitting 32 is coupled to the attachment extension 30. The hose fitting 32 is in fluid communication with the attachment extension 30 and is configured to receive a standard garden hose 34. The attachment extension 30 locates the hose fitting 32 closer to the ground to maximize reach and prevent entanglement with the garden hose 34. A plurality of supports 36 may extends between the plurality of legs 20 and the hose fitting 32 to create rigidity in the structure.

A flexible hose neck 38 is coupled to the top side 14 of the tripod platform 12 and is in fluid communication with the hose aperture 18. The flexible hose neck 38 flexes such that it can change shape and direction under the manipulation of a user's hand yet maintains shape under the forces of gravity and the flow of water passing therethrough. An adjustable spray nozzle 40 has an attachment end 42 coupled to a distal end 44 of the flexible hose neck and a spray end 46 having a plurality of apertures 48 to release the water from the flexible hose neck 38. The spray end may be rounded to further distribute the water. The adjustable spray nozzle 40 is tapered from the attachment end 42 to the spray end 46. The spray end 46 has an adjustment mechanism 50 to alter the flow rate and concentration of the water. The adjustment mechanism 50 may be a twist ring 52 coupled around a perimeter 54 of the spray end. The twist ring 52 may have a plurality of grooves 56 for added grip, particularly when wet. A valve 58 is coupled within the attachment end 42 of the adjustable spray nozzle and has a lever 60 to block and alternatively unblock the flow of water from the flexible hose neck 38 to the adjustable spray nozzle 40.

In use, the garden hose 34 is attached to the hose fitting 32 and is turned on. The flexible hose neck 38 is then manipulated until it is pointed in the desired direction and the lever 60 is turned to allow the water to flow through the valve 58. The twist ring 52 may then be rotated until the water sprays in the desired manner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tripod hose spray nozzle attachment comprising:
a tripod platform, the tripod platform having a top side and a bottom side, the top side having a hose aperture extending through the bottom side;
a plurality of legs coupled to the tripod platform, the plurality of legs being coupled to the bottom side and extending at an angle to form a tripod base;
a hose fitting coupled to the tripod platform, the hose fitting being coupled to the bottom side, the hose fitting being in fluid communication with the hose aperture, the hose fitting being configured to receive a standard garden hose;
a flexible hose neck coupled to the tripod platform, the flexible hose neck being coupled to the top side, the flexible hose neck being in fluid communication with the hose aperture, the flexible hose neck flexing such that it can change shape and direction under the manipulation of a user's hand yet maintaining shape under the forces of gravity and the flow of water passing therethrough; and
an adjustable spray nozzle coupled to the flexible hose neck, the adjustable spray nozzle having an attachment end coupled to a distal end of the flexible hose neck and a spray end having a plurality of apertures to release the water from the flexible hose neck, the spray end having an adjustment mechanism to alter the flow rate and concentration of the water.

2. The tripod hose spray nozzle attachment of claim 1 further comprising a valve coupled within the attachment end of the adjustable spray nozzle, the valve having a lever to block and alternatively unblock the flow of water from the flexible hose neck to the adjustable spray nozzle.

3. The tripod hose spray nozzle attachment of claim 1 further comprising the adjustment mechanism being a twist ring coupled around a perimeter of the spray end.

4. The tripod hose spray nozzle attachment of claim 3 further comprising the twist ring having a plurality of grooves for added grip.

5. The tripod hose spray nozzle attachment of claim 1 further comprising the adjustable spray nozzle being tapered from the attachment end to the spray end.

6. The tripod hose spray nozzle attachment of claim 1 further comprising an attachment extension coupled to the bottom side, the attachment extension being in fluid communication with the hose aperture, the hose fitting being coupled to the attachment extension.

7. The tripod hose spray nozzle attachment of claim 6 further comprising the attachment extension vertically extending down from the tripod platform between the plurality of legs.

8. The tripod hose spray nozzle attachment of claim 7 further comprising a plurality of supports extending between the plurality of legs and the hose fitting.

9. The tripod hose spray nozzle attachment of claim 1 further comprising each of the plurality of legs telescoping between a collapsed position and an alternate extended position.

10. The tripod hose spray nozzle attachment of claim 9 further comprising each of the plurality of legs having a locking clamp to maintain the collapsed position, the alternate extended position, or any intermediate position therebetween.

11. The tripod hose spray nozzle attachment of claim 1 further comprising a plurality of rubber feet coupled to the plurality of legs.

12. The tripod hose spray nozzle attachment of claim 1 further comprising the tripod platform being disc-shaped.

13. A tripod hose spray nozzle attachment comprising:
a tripod platform, the tripod platform having a top side and a bottom side, the top side having a hose aperture extending through the bottom side, the tripod platform being disc shaped;
a plurality of legs coupled to the tripod platform, the plurality of legs being coupled to the bottom side and extending at an angle to form a tripod base, each of the plurality of legs telescoping between a collapsed position and an alternate extended position, each of the plurality of legs having a locking clamp to maintain the collapsed position, the alternate extended position, or any intermediate position therebetween;
a plurality of rubber feet coupled to the plurality of legs;
an attachment extension coupled to the bottom side, the attachment extension vertically extending down from the tripod platform between the plurality of legs, the attachment extension being in fluid communication with the hose aperture;
a hose fitting coupled to the attachment extension, the hose fitting being in fluid communication with the attachment extension, the hose fitting being configured to receive a standard garden hose;
a plurality of supports extending between the plurality of legs and the hose fitting;
a flexible hose neck coupled to the tripod platform, the flexible hose neck being coupled to the top side, the flexible hose neck being in fluid communication with the hose aperture, the flexible hose neck flexing such that it can change shape and direction under the manipulation of a user's hand yet maintaining shape under the forces of gravity and the flow of water passing therethrough;
an adjustable spray nozzle coupled to the flexible hose neck, the adjustable spray nozzle having an attachment end coupled to a distal end of the flexible hose neck and a spray end having a plurality of apertures to release the water from the flexible hose neck, the adjustable spray nozzle being tapered from the attachment end to the spray end, the spray end having an adjustment mechanism to alter the flow rate and concentration of the water, the adjustment mechanism being a twist ring coupled around a perimeter of the spray end, the twist ring having a plurality of grooves for added grip;
a valve coupled within the attachment end of the adjustable spray nozzle, the valve having a lever to block and alternatively unblock the flow of water from the flexible hose neck to the adjustable spray nozzle.
